(19) United States
(12) Patent Application Publication
(10) Pub. No.: US 2022/0105600 A1
(43) Pub. Date: Apr. 7, 2022

(54) OPTICAL ELEMENT MANUFACTURING METHOD AND OPTICAL ELEMENT MANUFACTURING SYSTEM

(71) Applicants: LogistLab Inc., Tokyo (JP); KYOTO UNIVERSITY, Kyoto (JP)

(72) Inventors: Mikio KURITA, Kyoto (JP); Tsukasa OGINO, Tokyo (JP)

(21) Appl. No.: 17/551,189

(22) Filed: Dec. 15, 2021

Related U.S. Application Data
(63) Continuation-in-part of application No. PCT/JP2020/036300, filed on Sep. 25, 2020.

(30) Foreign Application Priority Data
Nov. 20, 2019 (JP) 2019-209437

(51) Int. Cl. B24B 13/01; C03C 19/00

(52) U.S. Cl. CPC B24B 13/01; C03C 19/00

(57) ABSTRACT

An optical element manufacturing method is a method for manufacturing an optical element by polishing an optical material, the method comprising the steps of mounting the optical material on a placing table, polishing the optical material using a polishing unit mounted on a processing machine movable above the placing table, and measuring a surface profile of the optical material using a measurement unit mounted on the processing machine.

### CROSS-REFERENCE TO RELATED APPLICATIONS

The present application is a continuation-in-part application of International Application number PCT/JP2020/036300, filed on Sep. 25, 2020, which claims priority under 35 U.S.C § 119(a) to Japanese Patent Application No. 2019-209437, filed on Nov. 20, 2019. The contents of these applications are incorporated herein by reference in their entirety.

### BACKGROUND OF THE INVENTION

The present disclosure relates to an optical element manufacturing method and an optical element manufacturing system. Japanese Unexamined Patent Application Publication No. 2010-6693 discloses a method for manufacturing an optical element used in an astronomical telescope by cutting a glass material into a predetermined shape after polishing.

In a conventional manufacturing method, a surface profile of a glass material is measured using an interferometer after polishing the glass material, and if a measurement result does not satisfy a predetermined condition, the glass material is further polished to manufacture an optical element having a desired profile. In this method, it is necessary to polish the glass material with the glass material placed on a polishing table and then measure its surface profile with the glass material placed on the interferometer. Therefore, there is a problem that it takes a long time to manufacture the optical element.

### BRIEF SUMMARY OF THE INVENTION

The present disclosure focuses on these points, and an object of the present disclosure is to reduce a time required for manufacturing an optical element.

### Effect of the Disclosure

A method for manufacturing an optical element of the first aspect of the present disclosure is a method for manufacturing an optical element by polishing an optical material, the method includes the steps of mounting the optical material on a placing table, polishing the optical material using a polishing unit mounted on a processing machine movable above the placing table, and measuring, after the polishing, a surface profile of the optical material using a measurement unit mounted on the processing machine.

An optical element manufacturing system of the second aspect of the present disclosure is an optical element manufacturing system for manufacturing an optical element by polishing an optical material, the system includes a placing table on which the optical material is placed, a processing machine that is movable above the placing table, wherein a polishing unit for polishing the optical material and a measurement unit for measuring a surface profile of the optical material can be removably mounted, and a controller that controls the processing machine such that the polishing unit is used to polish the optical material by moving the processing machine and the measurement unit is used to measure the surface profile of the optical material.

### BRIEF DESCRIPTION OF THE DRAWINGS

FIG. 1 is a perspective view of an optical element manufacturing system.

FIG. 2 is a schematic side view of the optical element manufacturing system.

FIG. 3 is a schematic diagram of a polishing unit as viewed from the side.

FIG. 4 is a schematic diagram of a measurement unit as viewed from the side.

FIG. 5 shows a configuration of a controller.

FIGS. 6A to 6D show an example of measurement results of a surface profile of an optical material.

FIG. 7 shows scanning directions of distance measurement sensors.

FIG. 8 is a flowchart of an optical element manufacturing method.

### DETAILED DESCRIPTION OF THE INVENTION

Hereinafter, the present invention will be described through exemplary embodiments of the present invention, but the following exemplary embodiments do not limit the invention according to the claims, and not all of the combinations of features described in the exemplary embodiments are necessarily essential to the solution means of the invention.

### [Configuration of Optical Element Manufacturing System S]

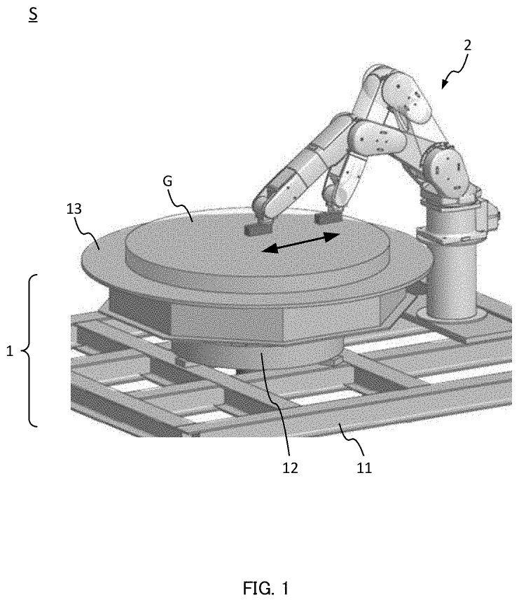

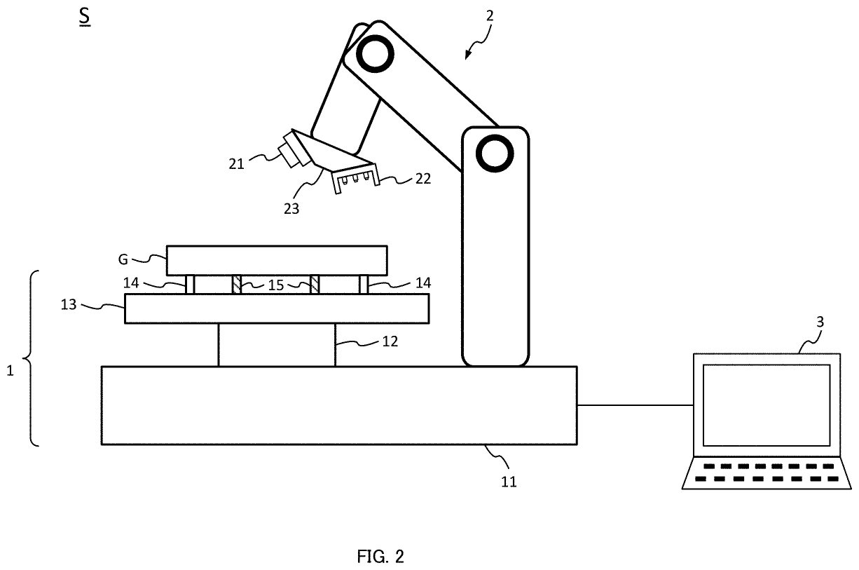

FIG. 1 is a perspective view of an optical element manufacturing system S. FIG. 2 is a schematic side view of the optical element manufacturing system S. The optical element manufacturing system S is a system for manufacturing an optical element by polishing an optical material G. The optical material G is a material of an optical element, and is glass, ceramics, resin, or metal, for example. The optical element is a mirror or a lens used in a telescope, for example.

The optical element manufacturing system S includes a body 1, a processing machine 2, and a controller 3.

The body 1 includes a base 11, a rotating part 12, a placing table 13, fixed support members 14, and movable support members 15. Details of a configuration of the body 1 will be described later.

The processing machine 2 is a device for polishing the optical material G placed on the body 1 and measuring the surface profile of the polished optical material G. The processing machine 2 has an actuator 20 including a) a plurality of shafts and b) joints coupling the plurality of shafts. The joints are driven by the controller 3 to move a position of a tip of the actuator 20 as indicated by an arrow in FIG. 1. A unit mounting part 23 to which a polishing unit 21 and a measurement unit 22 can be mounted is provided at the tip of the actuator 20. The processing machine 2 can polish and measure the optical material G using the polishing unit 21 and the measurement unit 22.

The controller 3 is an apparatus for outputting information for controlling operations of the body 1 and the processing machine 2, and is a computer, for example. The controller 3 controls the processing machine 2 to move the processing machine 2 to polish the optical material G using the polishing unit 21, and controls the processing machine 2 to measure the surface profile of the optical material G using the measurement part 22. The controller 3 executes a program stored in a storage medium (for example, a hard disk) to cause the processing machine 2 to polish the optical material G placed on the body 1 and measure the surface profile of the optical material G.

### [Configuration of Body 1]

The base 11 is a platform installed on a floor. A rotating part 12 is rotatably provided on the base 11. Further, the processing machine 2 is provided on the base 11. In the example shown in FIG. 2, the processing machine 2 is provided on the base 11, but the processing machine 2 may be installed at a position other than the base 11 (for example, on the floor).

The rotating part 12 rotates about a predetermined position under the control of the controller 3. The rotating part 12 has, for example, a cylindrical shape, and rotates about the center of the cylinder. The rotating part 12 rotates, for example, during polishing of the optical material G and measuring of the surface profile of the optical material G. The actuator 20 of the processing machine 2 and the rotating part 12 can move simultaneously to speed up shifting of the polishing position and the measurement position, but the rotating part 12 may be fixed without rotation.

The placing table 13 is a disc-shaped member coupled to the rotating part 12. The optical material G is placed on the placing table 13, and the placing table 13 rotates with the rotation of the rotating part 12 with the optical material G placed thereon. The placing table 13 is provided with a plurality of fixed support members 14 and a plurality of movable support members 15.

The plurality of fixed support members 14 and the plurality of movable support members 15 support the optical material G without over-constraining the optical material G. The fixed support member 14 is a rod-like member whose length does not change. The movable support member 15 is a rod-like member whose length changes. The movable support member 15 includes, for example, an elastic member (for example, a spring, a hydraulic cylinder, an air cylinder, or an elastic resin) which is displaced in the vertical direction, and changes its length according to the static pressure received from the optical material G. The movable support member 15 is preferably an object that can adjust a support position (for example, length) and a magnitude of a support reaction force. An elastic force of each of the movable support members 15 is designed such that the support reaction force generated at each support position of the plurality of movable support members 15 is equal to a reaction force generated at each support position when the optical element is installed in an optical device such as a telescope.

Since the optical material G is placed on the plurality of fixed support members 14 and the plurality of movable support members 15 in the body 1, the optical material G can be polished or the surface profile of the optical material G can be measured while the optical material G is horizontal, even if there is unevenness on the back surface of the optical material G. Therefore, the accuracy of the optical element manufactured by the optical element manufacturing system S can be improved.

### [Configuration of Processing Machine 2]

The processing machine 2 changes an angle of the unit mounting part 23 under the control of the controller 3 to switch between a state in which the polishing unit 21 for polishing the optical material G contacts the optical material G and a state in which the measurement unit 22 contacts the optical material G for measuring the surface profile of the optical material G.

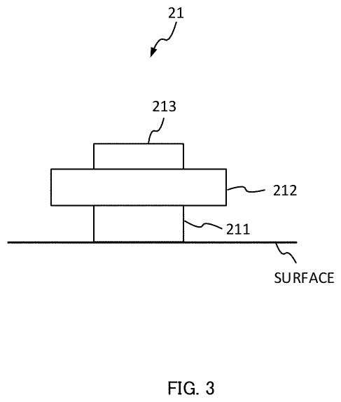

FIG. 3 is a schematic diagram of the polishing unit 21 as viewed from the side. The polishing unit 21 includes a polishing pad 211, a driving part 212, and a coupling part 213.

The polishing pad 211 is a disc-shaped member that contacts the surface of the optical material G while rotating to polish the surface of the optical material G. The polishing pad 211 is removably mounted to the driving part 212, and the user can appropriately replace the polishing pad 211.

The driving part 212 includes a motor for rotating the polishing pad 211. The driving part 212 rotates the polishing pad 211 by rotating the motor on the basis of an instruction from the controller 3.

The coupling part 213 is an interface for removably mounting the polishing unit 21 to the unit mounting part 23. The structure of the coupling part 213 is arbitrary, and a spiral groove having the same shape as a spiral groove of the unit mounting part 23 is formed on the outer surface of the coupling part 213, for example. The coupling part 213 may be locked by being inserted into a concave portion formed in the unit mounting part 23, and may be removed from the unit mounting part 23 by operating an unlocking part provided in the unit mounting part 23.

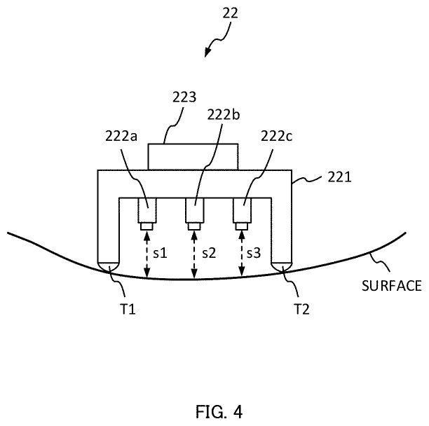

FIG. 4 is a schematic diagram of the measurement unit 22 as viewed from the side. The measurement unit 22 includes a contact part 221, a plurality of distance measurement sensors 222 (a distance measurement sensor 222a, a distance measurement sensor 222b, and a distance measurement sensor 222c), and a coupling part 223. The plurality of distance measurement sensors 222 are arranged at equal intervals on a straight line, for example.

The contact part 221 includes a tip T1 and a tip T2 protruding more than tips of the distance measurement sensors 222 (that is, the tip T1 and the tip T2 are located farther from the coupling part 223 than the tips of the distance measurement sensors 222), and the tip T1 and the tip T2 contact the surface of the optical material G. The contact part 221 is disposed on both sides of the plurality of distance measurement sensors 222 in alignment with the plurality of distance measurement sensors 222, for example. The plurality of distance measurement sensors 222 may be arranged in a straight line, and the contact part 221 may be arranged at a position other than on said straight line.

The measurement unit 22 continuously measures a distance from the distance measurement sensors 222 to the optical material G while continuously moving the contact part 221 in contact with the surface of the optical material G. The measurement unit 22 is stationary while the surface profile of the optical material G is measured by the distance measurement sensors 222. When the distance measurement sensors 222 change the position at which they measure the surface profile of the optical material G, the measurement unit 22 may change the position thereof in contact with the optical material G as the actuator 20 of the processing machine 2 moves. The measurement unit 22 is stationary while the surface profile of the optical material G is measured by the distance measurement sensors 222. When the distance measurement sensors 222 change the position at which they measure the surface profile of the optical material G, the measurement unit 22 may continuously measure the distance from the distance measurement sensors 222 to the optical material G by repeating the operation of changing the position thereof in contact with the optical material G as the actuator 20 of the processing machine 2 moves.

The distance measurement sensors 222 include three distance measurement sensors 222a, 222b, and 222c for measuring distances s1, s2, and s3 from the surface of the optical material G in order to measure the curvature of the optical material G. The distance measurement sensors 222a, 222b, and 222c measure the distances s1, s2, and s3 by irradiating the surface of the optical material G with light such as visible light or infrared light, and observing the interference intensity between light reflected by the surface of the optical material G and light reflected by end faces of the distance measurement sensors 222a, 222b, and 222c. The distance measurement sensors 222 output data indicating the measured distances s1, s2, and s3 to the controller 3 via the coupling part 223. The method for measuring the distance by the distance measurement sensors 222 is not limited to the above-described method, and may be any method.

### [Configuration of Controller 3]

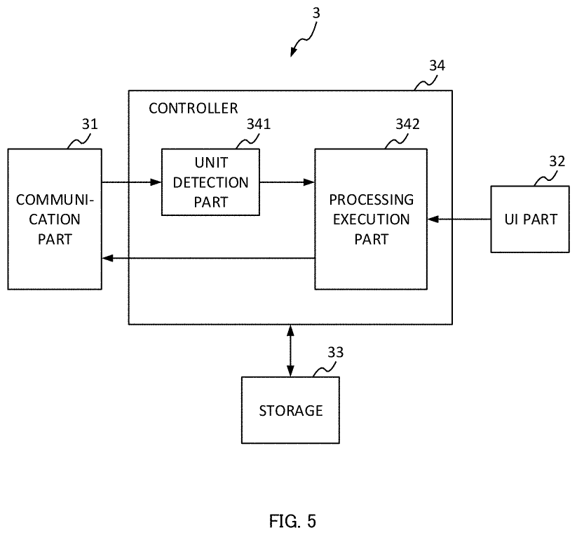

FIG. 5 shows a configuration of the controller 3. The controller 3 includes a communication part 31, a User Interface (UI) part 32, a storage 33, and a control part 34.

The communication part 31 is a communication interface for transmitting and receiving data to and from the processing machine 2, and includes, for example, a communication controller for connecting to a Local Area Network (LAN). The communication part 31 transmits instruction data for operating the processing machine 2, and receives state data indicating the state of the processing machine 2.

The UI part 32 is a device for receiving an operation by an operator, and includes a keyboard, a mouse, and a display, for example. The UI part 32 notifies the control part 34 of data indicating contents of the operation performed by the operator, and displays information for the operator.

The storage 33 includes a storage medium such as a Read Only Memory (ROM), a Random Access Memory (RAM), and a hard disk. The storage 33 stores a program executed by the control part 34.

The control part 34 includes, for example, a Central Processing Unit (CPU). The control part 34 functions as a unit detection part 341 and a processing execution part 342 by executing the program stored in the storage 33.

The unit detection part 341 detects which of the polishing unit 21 and the measurement unit 22 is mounted on the processing machine 2. Specifically, the unit detection part 341 detects a mounting state of the unit by acquiring the state data indicating the mounting state of the unit in the processing machine 2 via the communication part 31. The unit detection part 341 notifies the processing execution part 342 about the detected mounting state.

The processing execution part 342 causes the processing machine 2 to polish the optical material G and measure the surface profile of the optical material G when an operation for starting manufacturing of the optical element is performed by the UI part 32. Specifically, the processing execution part 342 causes the processing machine 2 to perform polishing under the condition that the unit detection part 341 detects that the polishing unit 21 is mounted, and causes the processing machine 2 to perform measurement under the condition that the unit detection part 341 detects that the measurement unit 22 is mounted.

Further, the processing execution part 342 may calculate the surface profile of the optical material G on the basis of the data measured by the measurement unit 22. For example, the processing execution part 342 can calculate a local curvature that is a curvature of the surface of the optical material G at each position on the basis of a) a position of the measurement unit 22 on the optical material G and b) data indicating distances at three positions acquired from the distance measurement sensors 222.

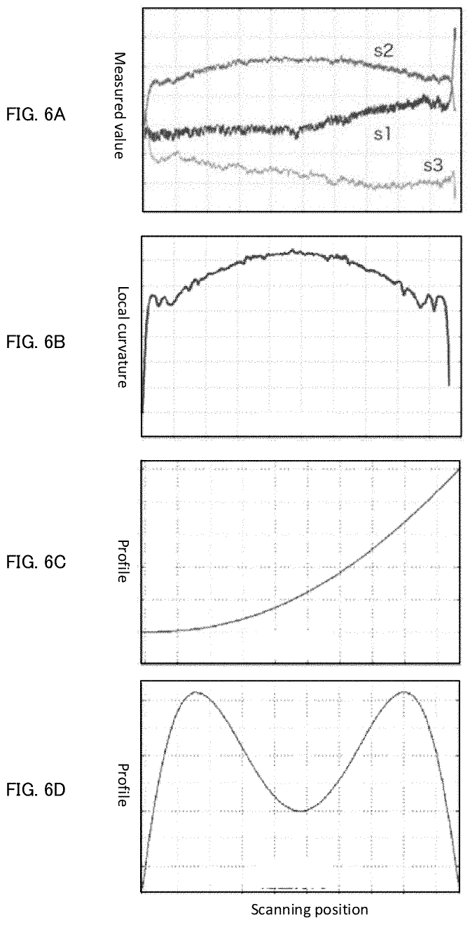

FIGS. 6A to 6D show an example of measurement results of the surface profile of the optical material G. FIG. 6A shows a relationship between the position on the optical material G and the measured values of the distances s1, s2, and s3. FIG. 6B shows a result of calculating the local curvature for respective scanning positions of the distance measurement sensors 222 on the basis of the measured values of the distances s1, s2, and s3 shown in FIG. 6A.

FIG. 6C shows a result of calculating the profile of the surface of the optical material G on the basis of the local curvature after removing an outlier in FIG. 6B. FIG. 6D shows a result of calculating the profile of the optical material G in the scanning direction by removing a secondary component from the result shown in FIG. 6C. The result shown in FIG. 6D is almost identical to the result measured by the interferometer, and it is confirmed that the surface profile of the optical material G can be measured with high accuracy by the distance measurement sensors 222, which are smaller than the interferometer.

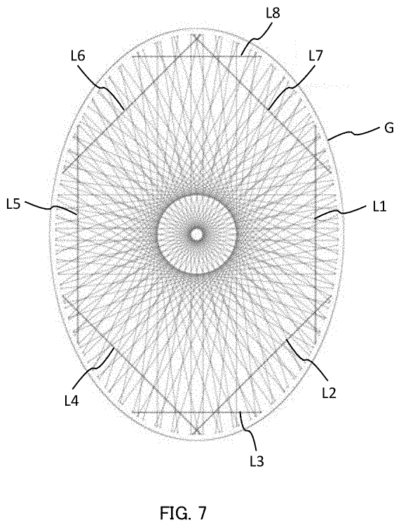

FIG. 7 shows scanning directions of the distance measurement sensors 222. An ellipse shown in FIG. 7 is an example of an outer peripheral line of the optical material G, and straight lines in the ellipse are the scanning directions of the distance measurement sensors 222. As shown in FIG. 7, the distance measurement sensors 222 perform a plurality of measurements in straight lines connecting the center of the placing table 13 and the position on the outer peripheral line (for example, the center of the optical material G and the position on the outer peripheral line). The distance measurement sensors 222 perform at least one measurement in a direction orthogonal to a radial direction of the placing table 13 (that is, the radial direction of the optical material G). The measurement positions in the direction orthogonal to the radial direction of the placing table 13 are shown by straight lines L1 to L8 in FIG. 7.

The controller 3 combines a plurality of results of the measurements in a plurality of directions shown by the straight lines in FIG. 7 to create measurement result data indicating the measurement result of the surface profile. By having the distance measurement sensors 222 operating in this manner, the processing machine 2 can efficiently measure the surface profile of the entire surface of the optical material G by moving the distance measurement sensors 222 in a linear fashion.

### [Flowchart of Optical Element Manufacturing Method]

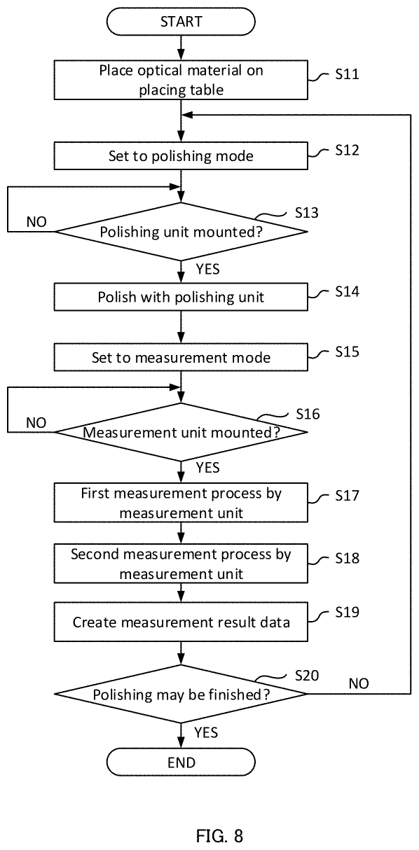

FIG. 8 is a flowchart of an optical element manufacturing method. First, the optical material G to be used for manufacturing the optical element is placed on the placing table 13 (step S11). Subsequently, an operation mode of the processing machine 2 is set to a polishing mode (step S12). The controller 3 executes application software for manufacturing an optical element, and operates the processing machine 2 in the polishing mode when an operation for starting manufacturing of an optical element from the user is received.

The controller 3 confirms that the polishing unit 21 is mounted on the processing machine 2 before the processing machine 2 starts polishing. That is, the controller 3 determines whether or not the polishing unit 21 is mounted at a position where the polishing unit 21 is to be mounted in the unit mounting part 23 (step S13). In order for the controller 3 to determine whether or not the polishing unit 21 is properly mounted, the unit mounting part 23 is configured, for example, to output a predetermined signal to the controller 3 if the polishing unit 21 is mounted and not to output the predetermined signal to the controller 3 if the polishing unit 21 is not mounted.

On a condition that the polishing unit 21 is mounted on the unit mounting part 23 (YES in step S13), the controller 3 instructs the processing machine 2 to start the polishing process by the polishing unit 21 (step S14). In a case where the controller 3 starts the polishing process on the basis of an instruction from the operator, the controller 3 may receive the instruction to start the polishing on a condition that the polishing unit 21 is confirmed to be mounted. In the polishing process, the controller 3 polishes the optical material G using the polishing unit 21 mounted on the processing machine 2, which is movable above the placing table 13.

If the polishing unit 21 is not mounted on the unit mounting part 23 (NO in step S13), the controller 3 may wait until the polishing unit 21 is mounted on the unit mounting part 23, or may output a warning. It should be noted that the processing machine 2 that receives the instruction for operating in the polishing mode from the controller 3 may determine whether or not the polishing unit 21 is mounted on the unit mounting part 23.

Subsequently, when the polishing is finished, the controller 3 sets the operation mode of the processing machine 2 to a measurement mode (step S15). The controller 3 confirms that the measurement unit 22 is mounted on the processing machine 2 before the processing machine 2 starts the measurement. That is, the controller 3 determines whether or not the measurement unit 22 is mounted at a position where the measurement unit 22 is to be mounted in the unit mounting part 23 (step S16). In order for the controller 3 to determine whether or not the measurement unit 22 is properly mounted, the unit mounting part 23 is configured, for example, to output a predetermined signal to the controller 3 if the measurement unit 22 is mounted and not to output the predetermined signal to the controller 3 if the measurement unit 22 is not mounted.

Under the condition that the measurement unit 22 is mounted on the unit mounting part 23 (YES in step S16), the controller 3 instructs the processing machine 2 to start the measurement process by the measurement unit 22. In a case where the controller 3 starts the measurement process on the basis of an instruction from the operator, the controller 3 may receive the instruction to start the measurement on the condition that the measurement unit is confirmed to be mounted. In the measurement process, the controller 3 uses the measurement unit 22 mounted on the processing machine 2 to measure the surface profile of the optical material.

If the measurement unit 22 is not mounted on the unit mounting part 23 (NO in S16), the controller 3 may wait until the measurement unit 22 is mounted on the unit mounting part 23, or may output a warning. It should be noted that the processing machine 2 that receives the instruction for operating in the measurement mode from the controller 3 may determine whether or not the measurement unit 22 is mounted on the unit mounting part 23.

When the processing machine 2 receives the instruction to start measurement from the controller 3, the processing machine 2 executes a first measurement process in which the measurement is performed a plurality of times along the straight lines connecting the center of the placing table 13 and the positions on the outer peripheral line (step S17). Subsequently, the processing machine 2 executes a second measurement process in which at least one measurement in the direction orthogonal to the radial direction of the placing table 13 is performed (step S18). Subsequently, the controller 3 creates measurement result data indicating a result of measurement of the surface profile by combining a plurality of first measurement results measured in the first measurement process and the second measurement result measured in the second measurement process (step S19).

The controller 3 analyzes the measurement result data to determine whether the polishing may be finished (step S20). If the controller 3 determines that the surface profile of the optical material G satisfies predetermined specifications (for example, the amount of unevenness on the surface of the optical material G is determined to be equal to or less than a threshold value), the controller 3 determines that the polishing may be finished (YES in step S20), and ends the polishing process of the optical material G.

If the controller 3 determines that the surface profile of the optical material G does not satisfy the predetermined specifications, the controller 3 determines that another polishing is necessary (NO in step S20), and returns to step S12. As described above, the controller 3 causes the processing machine 2 to sequentially repeat the polishing process and the measurement process, such that the optical element satisfying the predetermined specifications can be manufactured.

### [First Variation]

The above description illustrated that the polishing unit 21 and the measurement unit 22 are mounted on the unit mounting part 23 at the same time. However, either the polishing unit 21 or the measurement unit 22 may be mounted on the unit mounting part 23, and the unit mounting part 23 may be used by being switched between the state in which the polishing unit 21 is mounted on the unit mounting part 23 and the state in which the measurement unit 22 is mounted on the unit mounting part 23.

In this case, the polishing unit 21 is mounted to the processing machine 2 before the polishing, and the polishing unit 21 is removed from the processing machine 2 and the measurement unit 22 is mounted to the processing machine 2 before the measurement. The polishing unit 21 and the measurement unit 22 may be replaced by the operator or automatically by the processing machine 2. If the processing machine 2 automatically replaces the polishing unit 21 and the measurement unit 22, the polishing unit 21 and the measurement unit 22 may be accommodated in a predetermined accommodating position of the body 1, and the processing machine 2 may move the unit mounting part 23 to the accommodating position to mount/remove the polishing unit 21 and the measurement unit 22. The position of the polishing unit 21 and the position of the measurement unit 22 may be interchanged between the polishing process and the measurement process by having the tip of the actuator 20 rotated by the processing machine 2.

### [Second Variation]

The above description illustrated that the processing machine 2 polishes the optical material G and measures the surface profile of the optical material G, but the processing machine 2 may apply processes other than polishing to the optical material G. The processing machine 2 may grind the optical material G before the polishing and the measurement. In this case, the unit mounting part 23 is configured such that a grinding unit used for grinding can be mounted thereon, and when the grinding process is performed, the processing machine 2 grinds the optical material G by bringing the grinding unit into contact with the optical material G. The controller 3 may cause the processing machine 2 to grind on a condition that the grinding unit is mounted on the unit mounting part 23.

Further, the processing machine 2 may cut the optical material G into a predetermined size after the polishing and the measurement are finished. Specifically, the unit mounting part 23 is configured such that a water jet cutter for cutting the optical material G can be mounted thereon, and when the cutting process is performed, the processing machine 2 moves the position of the water jet cutter to the cutting position and then ejects water. The controller 3 may cause the processing machine 2 to cut on a condition that the water jet cutter is mounted on the unit mounting part 23.

### [Third Variation]

In the above description, the polishing position and the measurement position are controlled by the processing machine 2 by operating the actuator 20 to control the position of the polishing unit 21 or the measurement unit 22. Instead of or in addition to moving the actuator 20 of the processing machine 2 in this manner, the body 1 on which the optical material G is placed may be moved. By having the body 1 moving freely in the horizontal direction, the optical element manufacturing system S can polish the entire optical material G or measure the surface profile of the entire optical material G even if the horizontal position of the polishing unit 21 or the measurement unit 22 is fixed.

### [Effect of Optical Element Manufacturing System S]

As described above, the processing machine 2 is configured such that the polishing unit 21 for polishing the optical material G and the measurement unit 22 for measuring the surface profile of the optical material G can be removably mounted. Further, the controller 3 controls the processing machine 2 such that the polishing unit 21 is used to polish the optical material G, and the measurement unit 22 is used to measure the surface profile of the optical material G by moving the processing machine 2. Since the optical element manufacturing system S includes such a processing machine 2 and controller 3, there is no need to place the optical material G on a polishing device to polish the optical material G, and then move the optical material G to a device such as an interferometer for measuring the surface profile of the optical material G to measure the surface profile of the optical material G. As a result, the time required for manufacturing the optical element can be reduced.

Further, in the optical element manufacturing system S, the polishing and the measurement can be repeatedly executed with the optical material G placed on the body 1, such that errors between the polishing position and the measurement position are unlikely to occur. Therefore, the accuracy of polishing the optical material G is improved, compared with the case where the device is replaced between the polishing and the measurement.

The present invention is explained on the basis of the exemplary embodiments. The technical scope of the present invention is not limited to the scope explained in the above embodiments and it is possible to make various changes and modifications within the scope of the invention. For example, the specific embodiments of the distribution and integration of the apparatus are not limited to the above embodiments, all or part thereof, can be configured with any unit which is functionally or physically dispersed or integrated. Further, new exemplary embodiments generated by arbitrary combinations of them are included in the exemplary embodiments of the present invention. Further, effects of the new exemplary embodiments brought by the combinations also have the effects of the original exemplary embodiments.

What is claimed is:

1. A method for manufacturing an optical element by polishing an optical material, the method comprising the steps of:
mounting the optical material on a placing table;
polishing the optical material using a polishing unit mounted on a processing machine movable above the placing table; and
measuring, after the polishing, a surface profile of the optical material using a measurement unit mounted on the processing machine.

2. The method for manufacturing an optical element according to claim 1, wherein
the measuring measures the surface profile of the optical material using the measurement unit mounted on the processing machine, the measurement unit including three sensors for measuring the surface profile of the optical material.

3. The method for manufacturing an optical element according to claim 2, wherein
the measuring brings tips of a contact part, which protrude more than tips of the three sensors in the measurement unit, into contact with a surface of the optical material while measuring the surface profile of the optical material using the three sensors.

4. The method for manufacturing an optical element according to claim 3, wherein
the measuring continuously measures a distance from the three sensors to the optical material while continuously moving the contact part in contact with the surface of the optical material.

5. The method for manufacturing an optical element according to claim 3, wherein
the measuring causes the measurement unit to be stationary while measuring the surface profile of the optical material by the three sensors, and when the three sensors change the positions at which they measure the surface profile of the optical material, the measuring causes the measurement unit to change the position in contact with the optical material as the actuator of the processing machine moves.

6. The method for manufacturing an optical element according to claim 2, wherein
the measuring measures the surface profile of the optical material by measuring the distance between the three sensors and the optical material by observing the interference intensity between light, which is radiated onto the surface of the optical material by the sensors, reflected by the surface of the optical material and light reflected by end faces of the sensors.

7. The method for manufacturing an optical element according to claim 1, wherein
the polishing and the measuring are sequentially repeated.

8. The method for manufacturing an optical element according to claim 1, further comprising the steps of:
mounting the polishing unit to the processing machine prior to the polishing; and
removing the polishing unit from the processing machine and mounting the measurement unit prior to the measurement.

9. The method for manufacturing an optical element according to claim 1, wherein
the polishing includes the steps of:
confirming that the polishing unit is mounted on the processing machine, and
receiving an instruction to start polishing on a condition that the polishing unit is confirmed to be mounted on the processing machine on the basis of a predetermined signal outputted from the processing machine when the polishing unit is mounted on the processing machine.

10. The method for manufacturing an optical element according to claim 1, wherein
the measuring includes the steps of:
confirming that the measurement unit is mounted on the processing machine, and
receiving an instruction to start measurement on a condition that the measurement unit is confirmed to be mounted on the processing machine on the basis of the predetermined signal outputted from the processing machine when the measurement unit is mounted on the processing machine.

11. The method for manufacturing an optical element according to claim 1, further comprising the step of:
grinding the optical material using a grinding device mounted on the processing machine prior to the polishing.

12. The method for manufacturing an optical element according to claim 1, wherein
the polishing and the measuring rotate the placing table with a predetermined position of the placing table as a rotation center.

13. The method for manufacturing an optical element according to claim 12, wherein
the measuring includes the steps of:
a first measuring that performs a plurality of measurements on straight lines connecting a center of the placing table and positions on an outer peripheral line,
a second measuring that performs at least one measurement in a direction orthogonal to a radial direction of the placing table, and
generating measurement result data indicating a result of measuring the surface profile by combining a plurality of first measurement results measured in the first measuring and a second measurement result measured in the second measuring.

14. An optical element manufacturing system for manufacturing an optical element by polishing an optical material, the system comprising:
a placing table on which the optical material is placed;
a processing machine that is movable above the placing table, wherein a polishing unit for polishing the optical material and a measurement unit for measuring a surface profile of the optical material can be removably mounted; and
a controller that controls the processing machine such that the polishing unit is used to polish the optical material by moving the processing machine and the measurement unit is used to measure the surface profile of the optical material.

15. The optical element manufacturing system according to claim 14, wherein
the controller includes:
a unit detection part that detects which of the polishing unit and the measurement unit is mounted on the processing machine,
a processing execution part that executes the polishing under the condition that the unit detection part detects that the polishing unit is mounted, and executes the measurement under the condition that the unit detection part detects that the measurement unit is mounted.

16. The optical element manufacturing system according to claim 14, wherein
the measurement unit has three sensors for measuring the surface profile of the optical material, arranged at equal intervals on a straight line.

17. The optical element manufacturing system according to claim 16, wherein
the measurement unit further includes a contact part that protrudes more than tips of the three sensors and contacts the surface of the optical material while measuring the surface profile of the optical material using the three sensors.

18. The optical element manufacturing system according to claim 16, wherein
the measurement unit measures the surface profile of the optical material by measuring a distance between the three sensors and the optical material by observing an interference intensity between light, which is radiated onto the surface of the optical material by the three sensors, reflected by the surface of the optical material and light reflected by end faces of the three sensors.
